(19) United States
(12) Patent Application Publication
(10) Pub. No.: US 2020/0023766 A1
(43) Pub. Date: Jan. 23, 2020

(54) IN-TENT TRAILER

(71) Applicant: Pamela K. Sease, Hartley, IA (US)

(72) Inventor: Pamela K. Sease, Hartley, IA (US)

(21) Appl. No.: 16/511,303

(22) Filed: Jul. 15, 2019

Related U.S. Application Data
(60) Provisional application No. 62/699,823, filed on Jul. 18, 2018.

(51) Int. Cl. B60P 3/34; E04H 15/08

(52) U.S. Cl. CPC B60P 3/34; E04H 15/08

(57) ABSTRACT

A trailer with a sealable shell frame which can be opened at the rear to be used in combination with a collapsible tent which allows the trailer to be used as a waterproof bedroom. A 4×6 cover shell sits on an extended 4×8 frame. It has the split doors in the back to open and secure to the extended frame, making a 4×8 sleeping area when the tent is attached. The shell frame is preferably injection molded low density polyethylene.

The unit is illustrated in the attached pictures of a prototype, which are submitted as drawings.

### CROSS-REFERENCE TO A RELATED APPLICATION

This application claims the priority filing date of earlier filed provisional application 62/699,823 titled “In-Tent Trailer”, filed Jul. 18, 2018, which is incorporated by reference.

### FIELD OF THE INVENTION

This invention relates to a trailer, optionally convertible to a sleeping unit.

### BACKGROUND OF THE INVENTION

Trailers are of course, common place, as are covered trailers. However, trailers covered by a shell which can be extended with a tent canopy to provide a waterproof sealed bedroom at night and a convenient storage place for gear and the like during transport. Those few that do exist have typical problems of water seepage and leaking, the inability to effectively level or open for convenient ventilation when desired. This invention solves the above referred two problems by providing an extended trailer frame adaptable for attachment of a tent to a waterproof shell, sealably attached to the extended trailer frame, with the frame being capable of leveling and having rear doors that are openable or closeable at option of the user. At the rear end of the waterproof shell a tent attaching rail allows secure but releasable attachment of a tent awning to expand room. It therefore accomplishes and achieves an in-tent trailer that solves most of the problem with prior art units.

### SUMMARY OF THE INVENTION

A trailer with a sealable shell frame which can be opened at the rear to be used in combination with a collapsible tent which allows the trailer to be used as a waterproof bedroom. A 4×6 cover shell sits on an extended 4×8 frame. It has split doors in the back to open and secure to the extended frame, making a 4×8 sleeping area when the tent is attached. The shell frame is preferably injection molded low density polyethylene, although the olefins can be used.

### BRIEF DESCRIPTION OF THE DRAWINGS

FIG. 1 is a side view of the tent trailer combination of the present invention.

FIG. 2 is a front view of the tent trailer combination of the present invention.

FIG. 3 is a rear view of the tent trailer combination, with trailer doors closed.

FIG. 4 is a rear view with trailer doors open and tent poles installed.

FIG. 5 is a rear perspective view of the extended trailer, with the rear doors closed.

FIG. 6 is an exploded view showing how the tent poles fit together to support a tent canopy.

FIG. 7 is an exploded view of portion 7-7 of FIG. 5, showing the details of the tent attachment rail which is positioned on the shell opening perimeter.

### DETAILED DESCRIPTION OF THE PREFERRED EMBODIMENTS

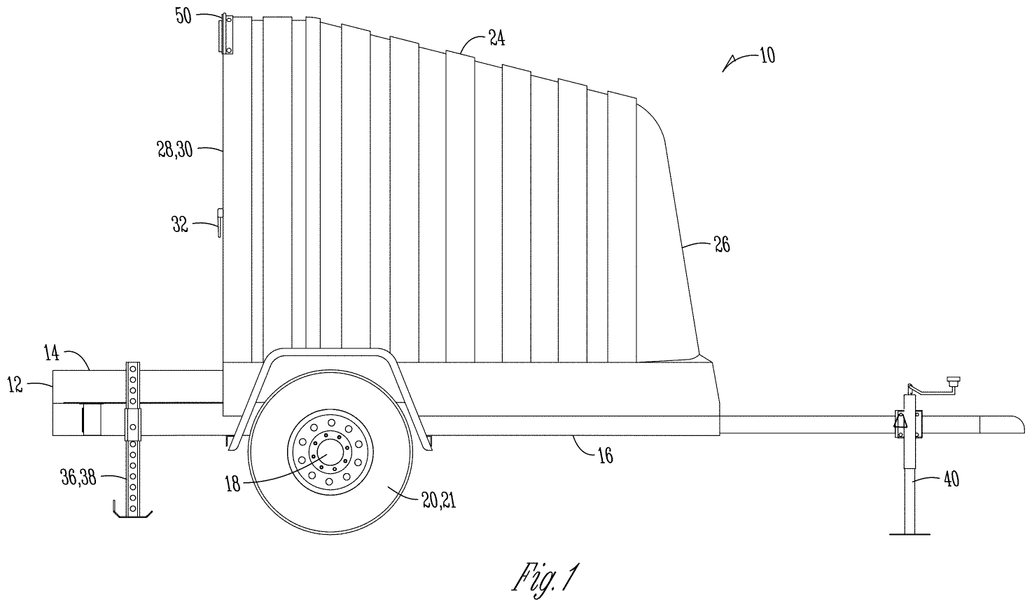

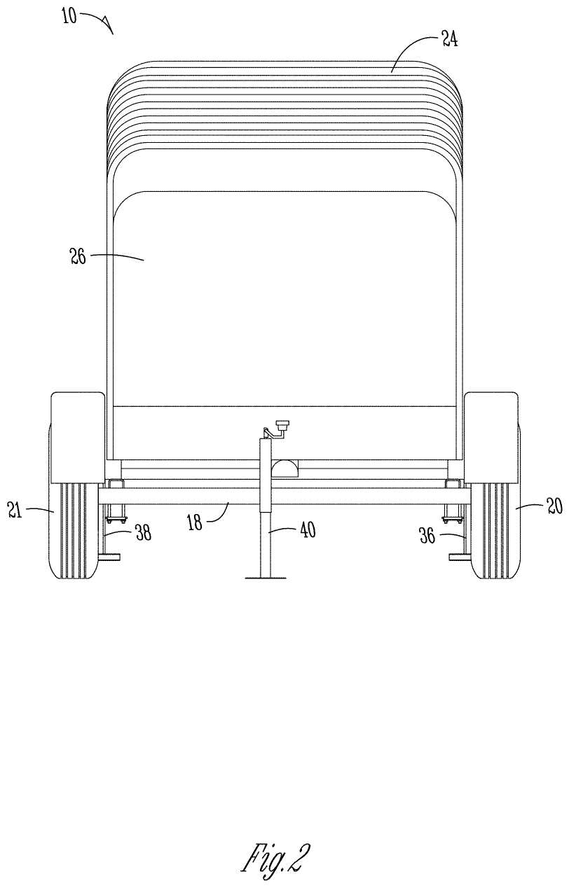

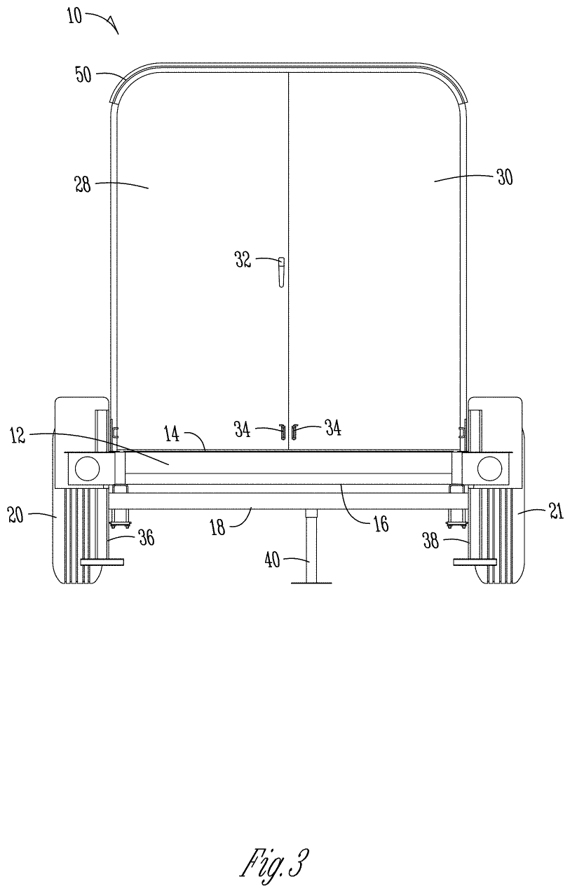

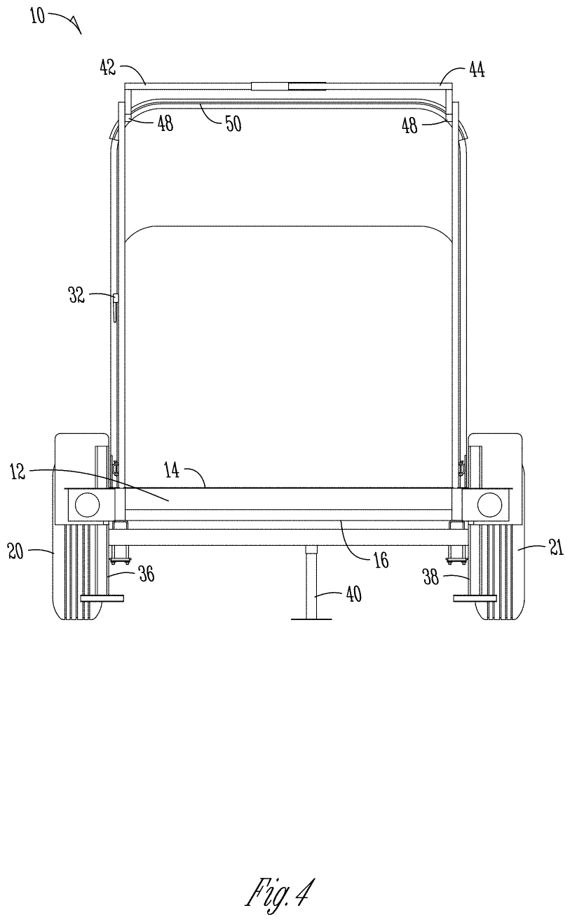

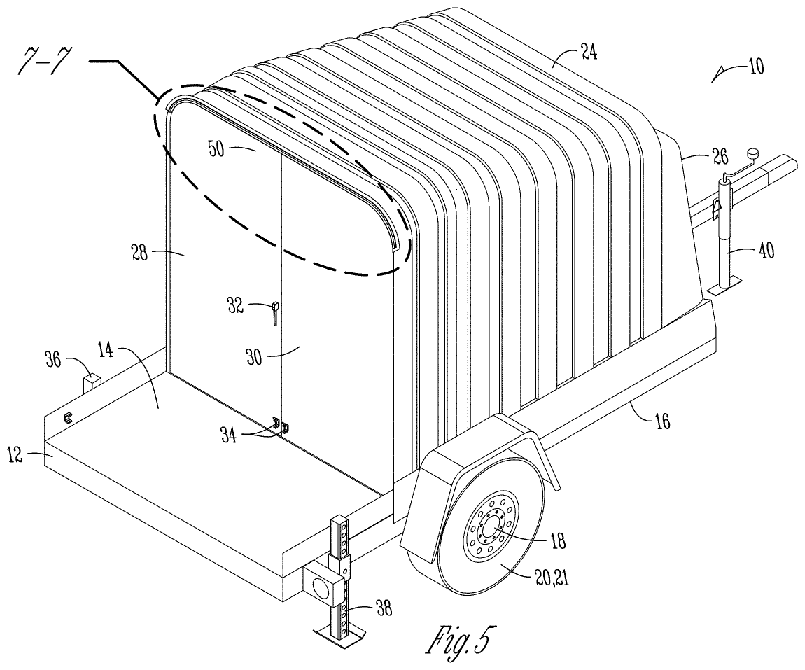

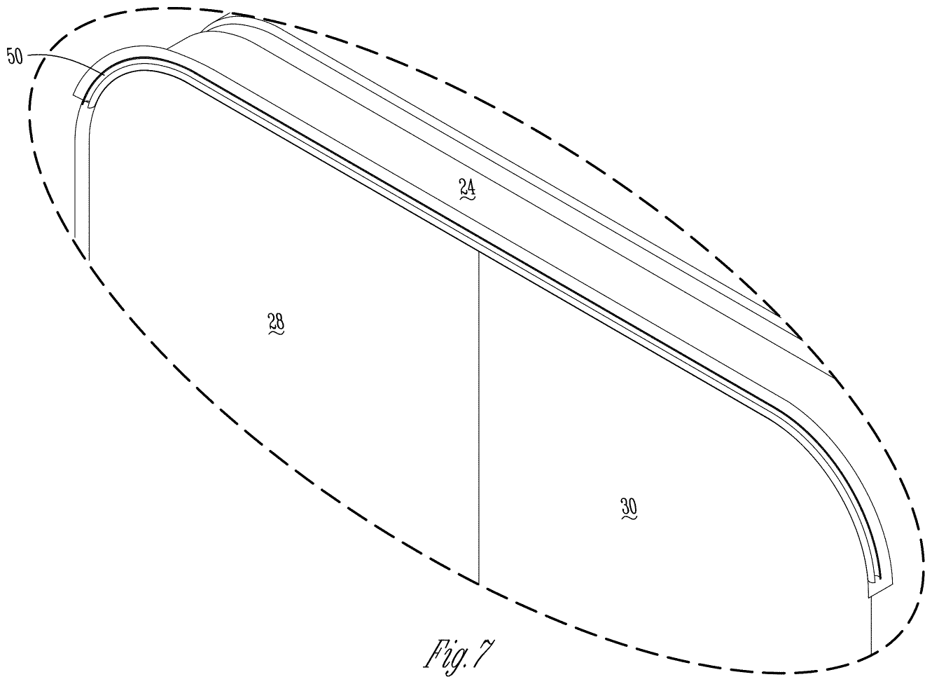

With continuing reference to the drawings, wherein FIGS. 1-7 like parts are numbered with the same number, a tent trailer generally referred to as 10 is comprised of an extended trailer frame 12 having a frame top of 14 and a frame bottom 16. Frame 12 has a mid-point axle 18 and wheels 20 and 21. Trailer rear end extends back and outward from an enclosed shell 24 mounted on the frame top 14 of trailer frame 12 with its rear portion extending over the mid-point axle and wheels 20 and 21. Enclosed shell 24 is completely and permanently closed at its front end 26 and is releasably closed at its rear end at doors 28, 30 which may be locked closed with hand lock 32. Doors 28 and 30 can swing open around hinges (not depicted) and be held securely in open position by door retainers 34.

Closed shell 24 is preferably made in an injection mold using low density polyethylene for injection rotomolding. Such techniques are known in the art and do not need to be described in detail. They usually involve heat and pressure and then injection of the low density polyethylene to a hot mold at a temperature from 20° to 70° C. a pressure up to 150 mP. After cooling the mold is opened and the completed shell is removed and bolted to top 14 of extended trailer frame 12.

It goes without saying that low density polyethylene is only one material that can be used to make the injection molded enclosure shell 24, and other similar injection moldable olefins may be utilized.

Adjustable levelers 36, 38 and 40 can be used to adjust the level of the frame well so that it is comfortable for sleeping.

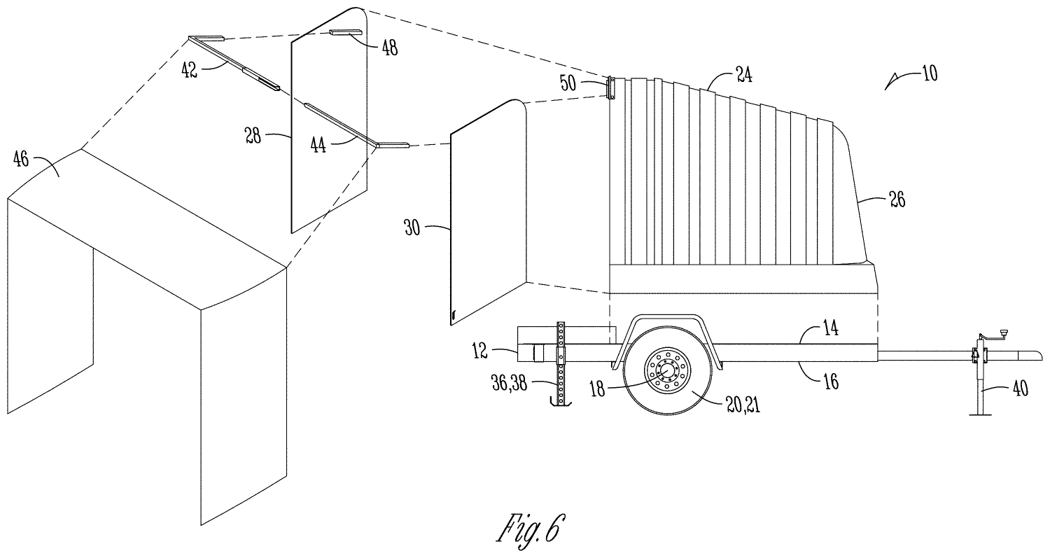

As best seen in exploded view of FIG. 6 and support poles 42, 44 with extension piece 46 may be put together and inserted into pole anchor 48. A like anchor not depicted but attached like anchor 48 to the opposing side of door 30 allows one to hold a support canopy securely at the open end of shell 24. A support canopy or tent can be fitted into tent rail 50 for secure attachment that provides leak proof attachment but at the same time is easily removable. When traveling the entire tent canopy structure can simply be taken down and placed inside of the trailer along with any other materials one wishes to store. Doors 28 and 30 are closed and lock by lock handle 32 for travel.

Upon reaching a desired camp site the trailer is leveled using leveler 36, 38 and 40, the canopy structure mounted in anchor's 48, at the back side of the tent it is locked and snapped into tent rail 50, the doors 28 and 30 opened all to provide a roomy sleeping compartment.

From the above description it can be seen that the invention accomplishes at least of all of its primary objectives it provides a convenient leak and seepage proof storage area during transit and a convenient evening and night time bedroom which can be quickly set up, leveled and used to the great convenience of it's owners. Therefore, it accomplishes at least all its stated objectives.

What is claimed is:

1. A tent trailer comprising:
a trailer frame having a top and bottom and a front tongue, a midpoint axle and wheels, and a trailer rear end;
an enclosed shell attached to the top of said frame, having a releasable door for closing an open end, opening toward said trailer rear end;
an extendible and removable collapsible tent and frame adopted to extend from said shell open rear end, rearwardly for supporting an extension canopy and tent when attached to said frame and enclosed shell.

2. The tent trailer of claim 1 wherein the trailer frame includes adjustable leveling legs.

3. The tent trailer of claim 1 which includes two doors which may be opened or closed.

4. The tent trailer of claim 1 wherein said tent is attached to said trailer by heavy duty snaps and a tent rail, said tent rail located adjacent the enclosed shell open end.

5. The tent trailer of claim 1 wherein said tent is attached to said shell by sliding onto a tent rail track on said shell.

6. The tent trailer of claim 3 which includes releasable door holds attached to said trailer frame for holding said releasable doors open.

7. The tent trailer of claim 1 wherein said shell is injection molded low density polyethylene.
